(19) United States
(12) Patent Application Publication
(10) Pub. No.: US 2004/0002034 A1
(43) Pub. Date: Jan. 1, 2004

(54) Custom dental tray

(76) Inventors: Scott Jacobs, Lakewood, CO (US); Robert Ibsen, Santa Maria, CA (US)

Correspondence Address: John S. Munday, Law Offices of John S. Munday, PO BOX 423, Isanti, MN, 55040, US

(21) Appl. No.: 10/185,039

(22) Filed: Jun. 28, 2002

(51) Int. Cl. A61C 9/00

(52) U.S. Cl. 433/48; 433/215

(57) ABSTRACT

A dental tray formed from an ethylene vinyl acetate polymer having a forming temperature between 115° F. and 145° F., and preferably between about 125° F. and 135° F. The preferred polymer is formed from a copolymer of ethylene and vinyl acetate in which the percent by weight vinyl acetate is at least 30% by weight and preferably between 33% and 40% by weight, with the remaining amount of the copolymer comprising ethylene. The dental tray can then be used for dental treatments including bleaching, fluoride applications, desensitizing teeth, antibacterial treatments and other dental operations.

### FIELD OF THE INVENTION

The present invention relates to making a dental tray customized to an individual patient's teeth, without the necessity of a professional's service. More particularly, the present invention relates to a dental tray that can be sized and shaped for a patient without the use of boiling water.

### BACKGROUND OF THE INVENTION

Dental trays are receptacles that are used to carry a medicine or dental hygiene materials, such as bleaching agents or fluoride application, and apply them to the teeth. It confines the material next to the teeth during the application.

There are two types of dental trays: stock and customized. Stock trays are pro-fabricated into a variety of standard sizes. They are used only for preliminary procedures and to produce impressions for casting as an interim step to creating more accurate dental trays and models of teeth. Custom trays are made by a dentist or technician by molding a material over a gypsum model of the patient's teeth. In order to get the gypsum model, a preliminary impression is made from the patient's teeth. The model requires at least one dental visit and requires a laboratory to construct the gypsum model.

Once the model is made, the customized dental tray is formed by the dentist or lab according to the limitations of the materials to be used for the tray. If the tray is made of thermoplastic sheets, the tray may be formed in a vacuum forming machine or other machine which exerts pressure. The sheets are placed in a soft state over the model and pressure is applied while the material sets.

This method requires additional work to finish the tray by removing excess material and doing a final fit of the patient, requiring at least one more visit to the dentist. The result is a customized tray, but at a large cost of time and professional service. U.S. Pat. No. 4,401,616 is an example of this method wherein the material is a thermoplastic such as Polyform. Similarly, U.S. Pat. No. 4,569,342 discloses another thermoplastic, methyl methacrylate, that is heated and formed over a gypsum cast. Both require trimming.

Another variation of this method is described in U.S. Pat. No. 5,112,225, where polycaprolactone polymer is used to make a dental tray, again using a gypsum model. The polycaprolactone polymer is then formed over the teeth by the dentist or technician.

In each of these prior methods, the customized dental tray depends upon a model first created from an impression, after an office visit and with the aid of a professional. The final tray then is made after another visit and additional time with a professional. The time and expense of such a tray can be very great. The majority of the preliminary work, such as the initial impression, the model, and the interim products, is not usable for any other patient. If the patient's teeth structure changes, even the patient cannot make use of these products.

The invention disclosed in U.S. Pat. No. 5,076,791, uses ethylene vinyl acetate and creates a customized dental tray without the necessity of a gypsum model. The resultant tray is so thick that it may cause discomfort. Additionally, it is not hard at normal temperatures and gives less than a custom fit.

Finally, U.S. Pat. No. 5,616,027 discloses a hard, thin dental tray, suitable for many types of dental and at home procedures and uses. The patent uses ethylene vinyl acetate for an outer, non-impression forming tray that can be softened using boiling water. The thin inner tray is customizable to the same accuracy as more expensive custom trays created on a model but at a fraction of the cost in time, professional expertise or equipment. The inner tray is principally made of a composition of polycaprolactone polymer with co-polymers and additives. The thin dental trays can be customized and molded in the home or outside of a dental office. The problem with this prior art tray and all the others of similar design is that it uses a polymer that can not be shaped at warm temperatures but requires higher temperatures to form, such as when the tray is heated in boiling water.

Since the early 1960s, there have been trays formable by the use of boiling water, which is far too hot for use with a patient. When the tray cools to a usable temperature, the window of pliability and comfort is so small that either the patient experiences discomfort or a bad fit is achieved.

Another industry where hot melting of thermoplastics is the athletic mouthguard industry. U.S. Pat. No. 3,312,218 teaches a protective mouthpiece that can be softened with boiling or near boiling water, then cooled to a temperature and formed in situ by the user. It has been found that a person normally can tolerate a thermoplastic at a temperature of less than 160° F. With a mouthguard, the fit is not as critical as it is with a dental tray but there is another important difference between mouthguards and dental trays. Specifically, mouthguards are thick and hold the heat longer, allowing the user to adjust the shape and fit over a longer period of time than is possible with the thinner and therefore faster cooling dental trays. Thus the window of time and temperature is much smaller for dental trays.

One embodiment of the present invention is a method for making a flexible custom dental tray using ordinary warm tap water without the necessity of boiling water.

Another embodiment for those who are self treating with over-the-counter products is to provide a method for making a flexible custom dental tray using ordinary warm tap water without the necessity of boiling water.

Other embodiments will appear hereinafter.

### SUMMARY OF THE INVENTION

The present invention is a dental tray of conventional shape, such as that shown in U.S. Pat. No. 5,616,027, although that dental tray is disclosed as being used as a carrier tray as well as the moldable inner tray. The dental tray of this invention is formed from an ethylene vinyl acetate copolymer having a forming temperature between 115° F. and 145° F. A preferred temperature is between about 125° F. and 135° F.

The dental tray of this invention may be used on either the upper or lower teeth. The tray of this invention may be used after changes in the teeth by reheating and redoing the forming process disclosed, in a much more effective and efficient manner than heretofore possible in the dental art. The tray may be made in multiple sizes to allow the selection of a size that generally conforms to the size of the patient's mouth

### DETAILED DESCRIPTION OF THE INVENTION

An important element of the invention is the use of a dental tray which is capable of being formed without heating to a potentially uncomfortable high temperature so that it will be formable at the molding or forming temperature.

In its simplest form the dental tray of this invention is made from an ethylene vinyl acetate copolymer having a forming temperature between 115° F. and 145° F. The copolymer is sized to generally to cover a patient's upper or lower teeth, and thus come in different shapes and sizes to accommodate different patients. The tray is conformed to the teeth at the forming temperature by applying pressure on the tray against the teeth. A preferred temperature is between about 125° F. and 135° F.

For the first time in dental practice, hot tap water can be used to soften the dental tray to a pliability which permits it to be accurately and precisely molded to the patients teeth, using hand pressure to complete the fitting to the patient.

The tray of this invention may be formed from a variety of the commercially available copolymers of ethylene and vinyl acetate, preferably where the percent by weight vinyl acetate is at least 30% by weight. Most preferred are copolymers of ethylene and vinyl acetate in which the percent by weight vinyl acetate is between 33% and 40% by weight. Similarly, the ethylene vinyl acetate copolymer should have a freezing point at which it is not deformable of less than 120° F., and preferably between about 80° F. and 106° F.

In a preferred embodiment, the copolymer is a mixture of two copolymers of ethylene vinyl acetate, each of the copolymers having different forming temperatures between 115° F. and 145° F., the different forming temperatures being at least 25° F. apart. For example, one of the copolymers could have a forming temperature of about 117° F. and a freezing temperature of about 81° F. and the other of the copolymers could have a forming temperature of about 145° F. and a freezing temperature of about 106° F. Most preferred are copolymers that combine to produce a tray having a forming temperature between about 125° F. and 135° F.

While any design for a dental tray is contemplated by the present invention, a typical dental tray has a generally horseshoe shape. The wall thickness of the ethylene vinyl acetate copolymer dental tray would be approximately between 0.26 mm to 1.25 mm (0.01 inches to 0.05 inches). A thickness that works well for the tray is 1 mm (0.04 in.). The outside wall of the inner tray is nearly perpendicular to its bottom wall, as is the inner wall.

Preferred ethylene vinyl acetate copolymers are manufactured by the DuPont Company under the trade name Elvax® ethylene vinyl acetate copolymer. Elvax® is a registered trademark of the DuPont Company. Preferred Elvax® copolymers are designated with a grade designation of Elvax® 40W and Elvax® 150. Presented below is a table showing some of the properties of the preferred materials.

TABLE I

| Elvax ® Grade | Vinyl Acetate | melting pt | freeze pt. |
|---|---|---|---|
| 40 W | 40% | 117° F. | 81° F. |
| 150 | 33% | 145° F. | 106° F. |

The tray is now ready for use. While particular embodiments of the present invention have been illustrated and described, it is not intended to limit the invention, except as defined by the following claims.

1. A dental tray, comprising:
an ethylene vinyl acetate copolymer having a forming temperature between 115° F. and 145° F.;
said copolymer being formed into a dental tray and being sized to generally to cover a patient's upper or lower teeth and be conformed to said teeth at said forming temperature by applying pressure on said tray against said teeth.

2. The tray of claim 1, wherein said forming temperature is between about 125° F. and 135° F.

3. The tray of claim 1, wherein said tray is formed from a copolymer of ethylene and vinyl acetate in which the percent by weight vinyl acetate is at least 30% by weight.

4. The tray of claim 3, wherein said tray is formed from a copolymer of ethylene and vinyl acetate in which the percent by weight vinyl acetate is between 33% and 40% by weight.

5. The tray of claim 1, wherein said ethylene vinyl acetate copolymer also has a freezing point at which it is not deformable of less than 120° F.

6. The tray of claim 5, wherein said freezing point is between about 80° F. and 106° F.

7. The tray of claim 1, wherein said copolymer is a mixture of two copolymers of ethylene vinyl acetate, each of said copolymers having different forming temperatures between 115° F. and 145° F., said different forming temperatures being at least 25° F. apart.

8. The tray of claim 7, wherein one of said copolymers has a forming temperature of about 117° F. and a freezing temperature of about 81° F.

9. The tray of claim 7, wherein the other of said copolymers has a forming temperature of about 145° F. and a freezing temperature of about 106° F.

10. The tray of claim 7, wherein said copolymers combine to produce a tray having a forming temperature between about 125° F. and 135° F.

11. A dental tray, comprising:
a copolymer formed from ethylene and vinyl acetate in which the percent by weight vinyl acetate is between 33% and 40% by weight;
said copolymer forming a tray having a forming temperature between 125° F. and 135° F. and a freezing point between about 80° F. and 106° F.;
said tray formed from said copolymer being sized to generally to cover a patient's upper or lower teeth and be conformed to said teeth at said forming temperature by applying pressure on said tray against said teeth.

12. The tray of claim 11, wherein said copolymer is a mixture of two copolymers of ethylene vinyl acetate, each of said copolymers having different forming temperatures between 115° F. and 145° F., said different forming temperatures being at least 25° F. apart.

13. The tray of claim 7, wherein one of said copolymers has a forming temperature of about 117° F. and a freezing temperature of about 81° F., the other of said copolymers has a forming temperature of about 145° F. and a freezing temperature of about 106° F., and said copolymers combine to produce a tray having a forming temperature between about 125° F. and 135° F.
